(19) United States
(12) Patent Application Publication
(10) Pub. No.: US 2025/0296820 A1
(43) Pub. Date: Sep. 25, 2025

(54) MOVABLE CABLE SPOOLING APPARATUS

(71) Applicant: Metiss B.V., Deventer (NL)

(72) Inventors: Raymond Harhuis, Deventer (NL); Koen Zeggelaar, Deventer (NL); Stefanus Antonius Johannes Spanjer, Deventer (NL)

(21) Appl. No.: 19/088,395

(22) Filed: Mar. 24, 2025

(30) Foreign Application Priority Data
Mar. 25, 2024 (EP) 24166008.3

(51) Int. Cl. B66D 3/00; B65H 75/40; B66D 1/36

(52) U.S. Cl. CPC B66D 3/006; B65H 75/403; B66D 1/36

(57) ABSTRACT

A movable cable spooling apparatus including a drum and a cable. The drum is arranged for winding and unwinding the cable. It may include a frame with wheels for moving the apparatus in which the frame supports the drum. It may include a cable guide forming an exit and entry for the cable to be wound on or unwound from the drum. The frame may include a rigid base plate that supports the drum and the cable guide. The cable may run adjacent to the rigid base plate between the drum and the cable guide.

### CROSS-REFERENCE TO RELATED APPLICATIONS

This application claims priority to and the benefit of European Patent Application No. 24166008.3, entitled “A MOVABLE CABLE SPOOLING APPARATUS”, filed Mar. 25, 2024, and the specifications and claims thereof are incorporated herein by reference.

### BACKGROUND OF THE INVENTION

### Field of the Invention

The invention relates to a movable cable spooling apparatus or winch, comprising a drum and a cable, wherein the drum is arranged for winding and unwinding the cable, said apparatus also comprising a frame, wherein the frame supports the drum, and said apparatus further comprises a cable guide forming an exit and entry for the cable to be wound on or unwound from the drum.

### Background

US2017/0088388 discloses such a movable cable spooling apparatus, wherein the frame forms part of a single axle trailer that supports the drum onto or from which the cable can be wound or unwound. This known apparatus is quite bulky and is not suited for manual handling without ancillary tracking means.

### BRIEF SUMMARY OF THE INVENTION

It is an object of the present invention to provide a movable cable spooling apparatus or winch of lightweight and low cost, which is capable of being handled manually. It is further intended to provide that the movable cable spooling apparatus of the invention brings about advantages that will become apparent from the following disclosure.

The movable cable spooling apparatus of the invention has the features of one or more of the appended claims.

According to a first aspect of the invention, the frame comprises a rigid base plate that supports the drum and the cable guide, wherein the cable runs adjacent to the rigid base plate between the drum and the cable guide. This keeps stresses exerted on the base plate low when the cable is loaded during use of the apparatus. The base plate can therefore be kept relatively thin and of low weight without compromising on the structural stability of the apparatus, which aids in keeping the ability to handle the apparatus of the invention at a high level.

To support the movability of the cable spooling apparatus, the frame is preferably provided with wheels.

Preferably the cable runs tangentially to and from the drum on a side of the drum that faces the base plate. In this way it is possible to keep the distance between the cable and the base plate as low as possible, and further it enables to provide a very compact design of the movable cable spooling apparatus of the invention.

It is preferable that the apparatus comprises an anchoring organ which is provided on a side of the base plate facing away from the cable guide and immediately opposite to the cable guide. This promotes that during use of the apparatus wherein the apparatus is (temporarily) suspended by the anchoring organ, the forces and moments acting on the anchoring organ remain relatively low.

Suitably the anchoring organ is a knob, or a cavity which is designed to cooperate with an external fixture for suspending the movable cable spooling apparatus from the external fixture.

In order to promote the ability to handle the movable cable spooling apparatus of the invention, it is preferred that the frame is equipped with a handlebar to enable a user to draw and move the frame with its wheels resting on the ground.

It is further desirable that the frame supports a closing cover so that the apparatus is embodied as a trolley.

According to another aspect of the invention the cable guide comprises a rotatable table that supports a first pulley and a second pulley that are placed on the rotatable table at a distance that enables the cable to be guided by and between the first pulley and the second pulley, wherein the cable runs perpendicular to and through the rotatable table. In this way the movable cable spooling apparatus of the invention is insensitive to the direction at which the cable is retracted or spooled back to the apparatus of the invention.

Beneficially the first pulley and the second pulley both have guards at opposite sides of the first pulley and the second pulley so as to prevent that the cable can leave the guidance by the first pulley and second pulley.

Preferably the drum is connected to a motor for driving the drum.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 illustrates a side view of a movable cable spooling apparatus according to an embodiment of the present invention;

FIG. 2 illustrates a top view of a movable cable spooling apparatus according to an embodiment of the present invention;

FIG. 3 illustrates a cable guide forming part of the movable cable spooling apparatus according to an embodiment of the present invention;

FIG. 4 illustrates a detail perspective view of an anchoring organ according to an embodiment of the present invention;

FIG. 5 illustrates a detail perspective view of another embodiment of an anchoring organ according to an embodiment of the present invention; and

FIGS. 6A and 6B illustrate perspective views of a movable cables pulley apparatus according to an embodiment of the present invention suspended from an external fixture.

### DETAILED DESCRIPTION OF THE INVENTION

Whenever in the figures the same reference numerals are applied, these numerals refer to the same parts.

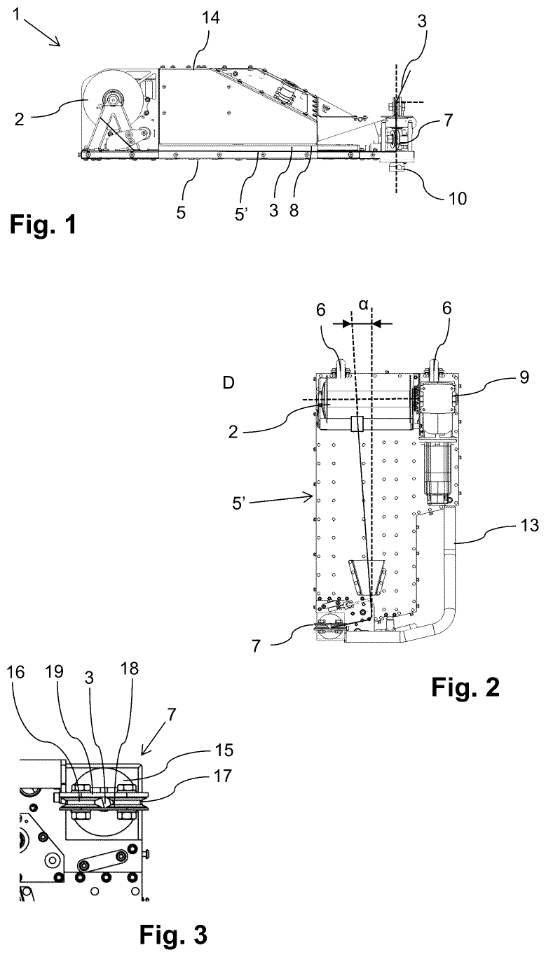

Turning first to FIG. 1 and FIG. 2, it shows movable cable spooling apparatus 1 comprising drum 2 and cable 3, wherein drum 2 is arranged for winding and unwinding cable 3, said apparatus 1 comprising further frame 5, which is preferably provided with wheels 6 for moving the apparatus, wherein frame 5 supports drum 2, and said apparatus 1 further comprises cable guide 7 forming an exit and entry for cable 3 to be wound on or unwound from drum 2.

Frame 5 is embodied with rigid base plate 5′ that supports drum 2 and cable guide 7, wherein cable 3 has section 8 that runs adjacent to rigid base plate 5′ between drum 2 and cable guide 7.

Particularly from FIG. 1 it is clear that cable 3 runs tangentially to and from drum 2 on a side of drum 2 that faces base plate 5′.

FIG. 2 shows that drum 2 is connected to motor 9 for driving drum 2.

FIG. 1 further shows that rigid base plate 5′ supports anchoring organ 10 which is mounted on a side of base plate 5′ facing away from cable guide 7 and immediately opposite to cable guide 7.

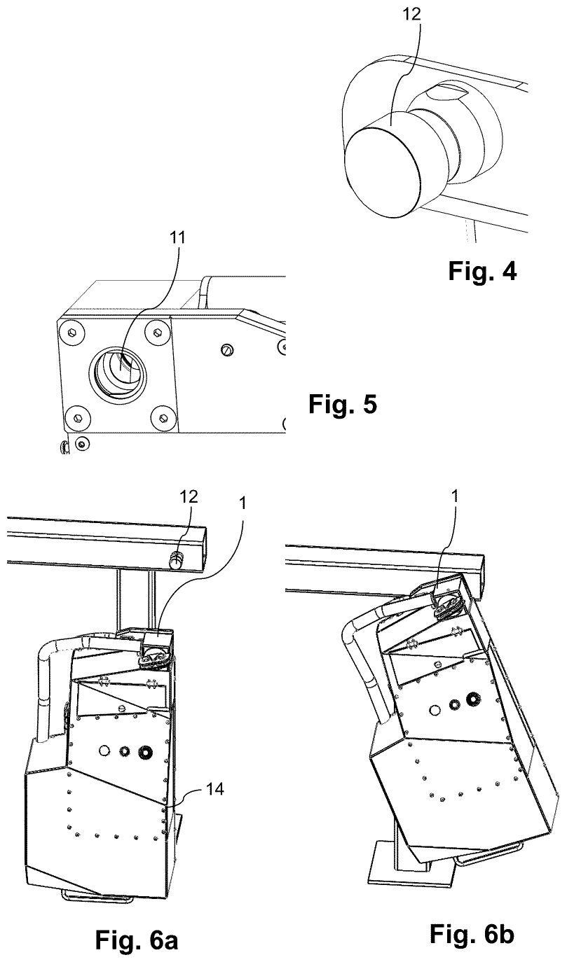

The anchoring organ can be embodied in different ways, to note that the anchoring organ can be knob 10 as shown in FIG. 1, or cavity 11 as depicted in FIG. 5. In case the anchoring organ is cavity 11 as shown in FIG. 5, same is designed to cooperate with an external fixture embodied as knob 12 externally of the apparatus (see FIG. 4 and FIG. 6A) for suspending movable cable spooling apparatus 1 from the external fixture. This is shown in FIG. 6B. FIG. 6A shows movable cable spooling apparatus 1 when not (yet) suspended.

Turning back to FIG. 2, it is shown that frame 5 is equipped with handlebar 13, which may be telescopically extendable, to enable a user to draw and move frame 5 with its wheels 6 resting on the ground. FIGS. 6A and 6B in turn show that the frame supports a closing cover 14 (also shown in FIG. 1) so that apparatus 1 is embodied as a trolley.

With reference to the detail drawing shown in FIG. 3, it shows that cable guide 7 comprises rotatable table 15 that supports first pulley 16 and second pulley 17 that are placed on rotatable table 15 at a distance that enables the cable to be guided by and between first pulley 16 and second pulley 17, wherein the cable runs perpendicular to and through rotatable table 15. First pulley 16 and second pulley 17 both have guards 18, 19 at opposite sides of first pulley 16 and second pulley 17.

Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claim to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

1. A movable cable spooling apparatus comprising:
a drum;
a cable, wherein the drum is arranged for winding and unwinding the cable;
a frame, wherein the frame supports the drum;
a cable guide forming an exit and entry for the cable to be wound on or unwound from the drum;
wherein the frame comprises a rigid base plate that supports the drum and the cable guide; and
wherein the cable runs adjacent to the rigid base plate between the drum and the cable guide.

2. The movable cable spooling apparatus of claim 1, wherein the frame comprises wheels for moving the apparatus.

3. The movable cable spooling apparatus of claim 1, wherein the cable runs tangentially to and from the drum on a side of the drum that faces the base plate.

4. The movable cable spooling apparatus of claim 1, wherein the apparatus comprises an anchoring organ which is mounted on a side of the base plate facing away from the cable guide and straightly opposite to the cable guide.

5. The movable cable spooling apparatus of claim 4, wherein the anchoring organ is a knob or a cavity which is designed to cooperate with an external fixture for suspending the movable cable spooling apparatus from the external fixture.

6. The movable cable spooling apparatus of claim 2, wherein the frame comprises a handlebar to enable a user to draw and move the frame with its wheels resting on the ground.

7. The movable cable spooling apparatus of claim 1, wherein the frame supports a closing cover.

8. The movable cable spooling apparatus according to claim 1, wherein the cable guide comprises a rotatable table that supports a first pulley and a second pulley that are placed on the rotatable table at a distance that enables the cable to be guided by and between the first pulley and the second pulley, and wherein the cable runs perpendicular to and through the rotatable table.

9. The movable cable spooling apparatus of claim 8, wherein the first pulley and the second pulley both have guards at opposite sides of the first pulley and the second pulley.

10. The movable cable spooling apparatus of claim 1, wherein the drum is connected to a motor for driving the drum.
